(19) United States
(12) Patent Application Publication
(10) Pub. No.: US 2017/0039665 A1
(43) Pub. Date: Feb. 9, 2017

(54) SYSTEM AND METHOD TO MANAGE LETTERS OF RECOMMENDATION

(71) Applicants: Brian Edward Bodkin, Chester, NJ (US); Barbara Jean Wyskowski, Chester, NJ (US)

(72) Inventors: Brian Edward Bodkin, Chester, NJ (US); Barbara Jean Wyskowski, Chester, NJ (US)

(21) Appl. No.: 15/299,138

(22) Filed: Oct. 20, 2016

Related U.S. Application Data
(63) Continuation-in-part of application No. 14/560,692, filed on Dec. 4, 2014.
(60) Provisional application No. 62/243,763, filed on Oct. 20, 2015.
(60) Provisional application No. 61/912,083, filed on Dec. 5, 2013.

(51) Int. Cl. G06Q 50/20; G06Q 10/10

(52) U.S. Cl. CPC G06Q 50/205; G06Q 10/10

(57) ABSTRACT

A tool to assist applicants for positions, such as students seeking admission to a particular institution, and more particularly, to systems and methods to assist applicants and references through the letter of recommendation process. The system employs a database of recommended questions for an applicant to submit to a reference to guide the reference's drafting and organization of a letter of recommendation. The system allows an applicant to prepare, transmit, track progress of requests, manages responses, and permits submissions by incorporating a unique user ID associated with the applicant's account.

### CROSS-REFERENCE TO RELATED APPLICATION

This application claims the benefit of priority of U.S. provisional patent application No. 61/912,083, filed Dec. 5, 2013; U.S. patent application Ser. No. 14/560,692, filed Dec. 4, 2014; and U.S. provisional patent application No. 62/243,763, filed Oct. 20, 2015, the contents of which are herein incorporated by reference.

### BACKGROUND OF THE INVENTION

The present invention relates to tools to assist applicants for positions, such as students seeking admission to a particular institution, internship, scholarship or grant, and more particularly, to systems and methods to assist applicants and references through the letter of recommendation process.

Applications for acceptance into colleges, scholarships, internships and grants generally require letters of recommendation. At the present time, the methodology for an automated web-based solution to this process does not exist. Generally, both applicants and references have little experience in this process and as a result, the letter of recommendation process is random and the results are often incomplete and unprofessional. Applicants do not know what questions to ask and references do not know how to respond or prepare a written recommendation. An incomplete and inadequate letter of recommendation could cost the applicant an opportunity for enrollment, scholarship or grant. Applicants often hire college application consultants to handle the letter of recommendation process.

The applicant's reference may range from handwritten to typewritten on a piece of paper with unstructured responses and without any consistency or standardization from one reference to another. Letters are in a hardcopy format and must be photocopied and then mailed or faxed with the application.

To a young applicant, the process of managing the letter of recommendation process can be a daunting task. The content of the recommendation should highlight the right combination individual qualities, abilities, skillsets, personality, responsibility and aptitude. An applicant only has one chance to impress admissions officers and internship, scholarship or grant programs. Invention users have a very favorable opinion of how the invention guided them through the letter of recommendation process and the ability to manage and control the process and the letters of recommendations created by this process.

As can be seen, there is a need for a system and method to guide applicants in soliciting and obtaining a letter of reference and for guiding a reference in preparing a letter of reference.

### SUMMARY OF THE INVENTION

In one aspect of the present invention, a computer implemented method for managing letters of recommendation for an applicant applying to a position is disclosed and claimed. The computer implemented method receives an applicant's request to initiate a request for a letter of recommendation to one or more reference providers identified according to a reference type. The method presents a plurality of reference questions to the applicant based on the selected reference type. An applicant's assignment of the one or more reference providers to a selected group of the plurality of reference questions to solicit a recommendation based on the assigned reference questions is received. The method automatically generates an e-mail request to the one or more reference providers, wherein the e-mail contains the assigned reference questions for the one or more reference providers The method includes transmitting the e-mail request to the one or more reference providers. The reference type may include one or more of an employer, a teacher, an instructor, a professor, a coach, a volunteer coordinator, an organizational representative, and an internship coordinator.

The computer implemented method may receive the details of the applicant's interactions with identified reference provider from the applicant. It may also generate the e-mail request to include the applicant entered details of the applicant's interactions with the reference provider. The computer implemented method automatically receives a response to the assigned reference questions from the reference provider, where the response is automatically linked to the applicant's account via a code transmitted with the e-mail request. The method is configured to generate a letter of recommendation based on the reference provider's response. As part of the process, an authenticated copy of the letter of recommendation is provided to an admissions office. In some embodiments, a link to the authenticated copy of the letter of recommendation is transmitted to the admissions office.

In other embodiments a reference question editor is provided to permit the applicant to select the reference questions. The reference question editor may also be configured to receive a customized reference question from the applicant.

Other aspects of the invention may include a computer program product for managing letters of recommendation for an applicant applying to a position, the computer program product comprising executable instructions which, when executed by one or more processors, cause the one or more processors to carry out steps of the foregoing computer implemented method.

These and other features, aspects and advantages of the present invention will become better understood with reference to the following drawings, description and claims.

### BRIEF DESCRIPTION OF THE DRAWINGS

FIG. 1 is a screenshot of an embodiment of a homepage of a system according to aspects of the invention.

FIG. 2 is a second representative screenshot illustrating a menu system and reference type submenu implementing a letter of recommendation system.

FIG. 3 is a third representative screenshot illustrating the menu system and a manage recommendations submenu implementing a letter of recommendation system.

FIG. 4 is a fourth representative screenshot illustrating the menu system and a manage letters submenu implementing a letter of recommendation system.

FIG. 5A is a first part of a flowchart implementing a letter of recommendation a letter of recommendation system and method.

FIG. 5B is a continuation of the flowchart of FIG. 5A.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an integrated digital system and method for applicants to initiate and manage letters of recommendation that are often required when applying to a school, college, and internship or for scholarships and grants. The invention is preferably a web-based system and method that can be accessed by applicants, references, schools and programs offering scholarships, grants and internships. The system and method may be accessible anywhere from a computer, tablet or cell phone by both students, reference providers, and admissions officers.

According to aspects of the invention, the letter of recommendation process may be standardized across all users and provides a resume or application enhancement tool to an applicant, a school or other application process participant. The invention provides specific instructions and directions to applicants and reference providers with industry best practices to engage references and prompt reference providers to respond to relevant information about the applicant. The responses from references are managed and collated into a single letter of recommendation report that is available to the applicant online. The letter of recommendation report that is created by the system can be e-mailed, included with a digital or standard application, faxed or mailed to appropriate parties and accessible to all parties with a computer, tablet or cell phone.

The system and method of the invention art fulfills the need for an easy to use process that utilizes data and a structured process for the applicant and create a database of customized sample questions to guide the applicant in the preparation of a letter of recommendation request to a selected reference. The questions are derived as a result of quantitative research gathered through interviews and surveys with high school guidance counselors and college admissions officers. The invention utilizes best practices relating to the types of references that add gravitas to the user's letter of recommendation. The research also included the optimal format of the completed letter of recommendation created by the invention that is brief, easy to use, to the point and informative to the reference recipient.

The invention utilizes data driven surveys and interviews with high school guidance counselors and college admissions officers to create a database of questions. The invention draws from this database to create unique questions for on each reference type (i.e. teacher, coach, instructor, employer, internship, participation in a volunteer, civic or religious organization) and interaction. Additionally, research developed formats that will elicit informative responses from references that the invention will utilize to create a professional letter of recommendation.

As use of the invention progresses, the system may utilize ongoing data analytics to update the research and modify the database entries as results from surveys are gathered from users, references, guidance counselors and college admissions officers. Data is evaluated for its usefulness to the invention, the invention's users, references and recipients who receive the completed letter of recommendation from an applicant.

The data analytics includes review of surveys and interviews with high school guidance counselors and college admissions officers to create a database of questions that the invention will utilize to create unique questions based on the reference type (i.e. teacher, coach, instructor, employer, internships, as well as participation in a volunteer, civic or religious organizations). Additionally, research developed formats that will elicit informative responses from references that the invention will utilize.

According to aspects of the invention, the system assists an applicant with generating pertinent questions that will prompt references to respond to areas that will highlight the applicant's abilities. The invention automates the letter of recommendation process with an interactive web-based software program. The invention includes problem-solving solutions for the applicant during the process. Applicants and references are provided guidance through each step in the process.

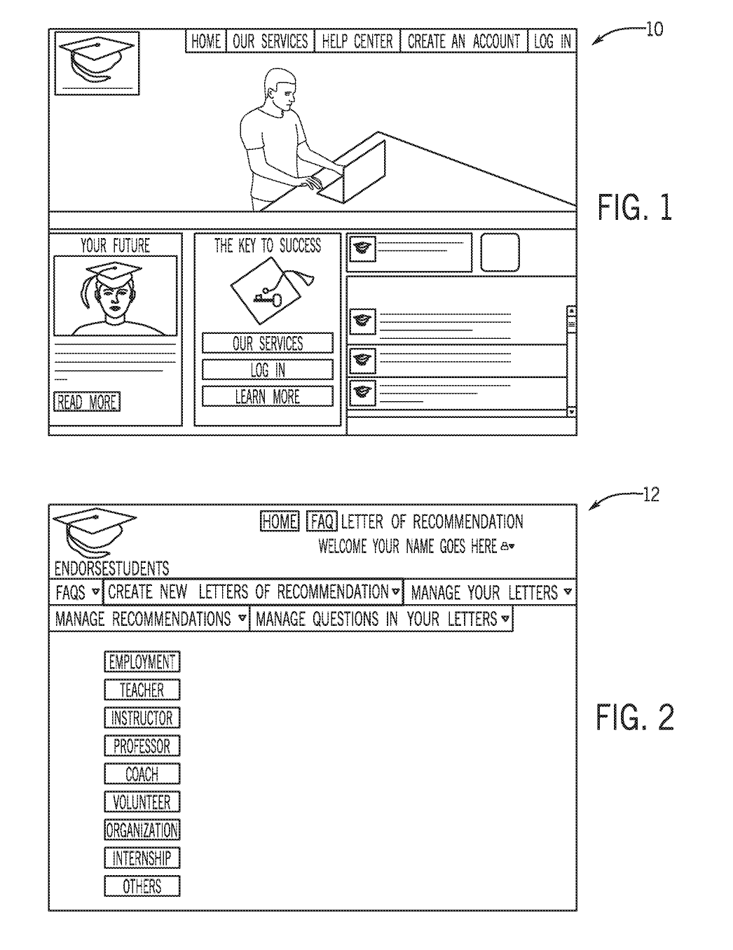

As seen in reference to FIG. 1, a representative home page of a system 10 is illustrated. The homepage provides links to permit an applicant to create an account in the system, or to access their account if they have already established one. The home page may also provide links to instructional material to assist applicants and references understand the process.

As seen in reference to FIG. 2, an embodiment of an applicant dashboard 12 provides links to the various modules within the system. In this embodiment, the applicant may select from links to create new letters of recommendation, manage letters of recommendation in progress, manage the formulation of requests for recommendation questions and the identification reference providers having input pertinent to the recommendation questions, and manage questions in the applicant's reference solicitation letters. Tips regarding the module selections may be provided by hovering a user input device, such as a cursor, over a selection.

In response to an applicant selecting the “Create New Letters of Recommendation,” the applicant is presented a selection screen in which they can identify a type of reference from whom they are seeking a letter of recommendation. A representative reference type selection screen is depicted in reference to FIG. 2. By selecting the type, the system creates recommended questions for the applicant's selected references based on the type of reference and the typical interactions an applicant may have had with that reference type, based on the relationship between the applicant and the reference provider.

After the applicant has entered the reference type, (teacher, employer, mentor, etc.) the system presents a reference data entry screen for the applicant to enter the name and contact information for each reference and a brief description of their interaction with the reference.

The system may also present the applicant a reference questionnaire to assist the applicant in soliciting a letter of recommendation and to guide the reference in the preparation of the letter of recommendation. Based on the type of application and the reference type, the system may automatically generate and present the applicant a list containing a plurality of questions from which to select in soliciting a letter of recommendation from a reference. In preferred embodiments, the questions are presented and sequenced so as to guide the applicant in asking the right questions of their references. A second listing presents a selection or question assignment entry portion of the system that permits the applicant to select one or more identified references that may be best suited to answer one or more of the questions displayed in the list of questions. This allows the applicant to ensure each pertinent question receives an assignment of one or more reference providers to answer the question and allows the applicant to assign reference providers to the questions based on the strength of the relationship or performance skills the applicant may have with the reference provider for that question.

The sequencing of the questions may also be organized so as to provide the reference with the body of the letter of recommendation solicitation. For example, the questions may include an introduction to allow the reference to briefly describe themselves. An interaction question may include an interaction to orient the reference and provide context to the reference provider's interactions with the applicant. An attributes question may be provided to discuss qualities, skills, and performance within the context of the applicant's and reference provider's relationship. The questions may also prompt the reference provider for an overall summary of the applicant and the reference's recommendation of the applicant for the position.

Through a manage questions module, the system may also permit the applicant to customize their solicitation by presenting the applicant the opportunity to add their own questions, that may direct the reference provider to a specific incident, event, activity or perhaps to reacquaint the reference with the applicant. As will be appreciated, through the invention, the applicant may be guided by the structure and scope of the representative questions to assist them in formulating their own questions to present to the reference provider. The applicant is also presented the option to delete suggested questions in forming their questionnaire.

After completing their questionnaires of the previous module, the applicant is given the opportunity to review their solicitation questionnaire by selecting the Manage Your Letters module. The applicant is shown the questions and the arrangement of the questions that will be presented to their intended reference. The system may also present the applicant a formatted e-mail correspondence for the applicant to send the questionnaire to the reference. After review, the applicant may send the solicitation directly from within the system. The system generates an email that will prompt reference providers to respond to the specific questions based upon our research that are tailored to the type of reference and the applicant's experience with that reference.

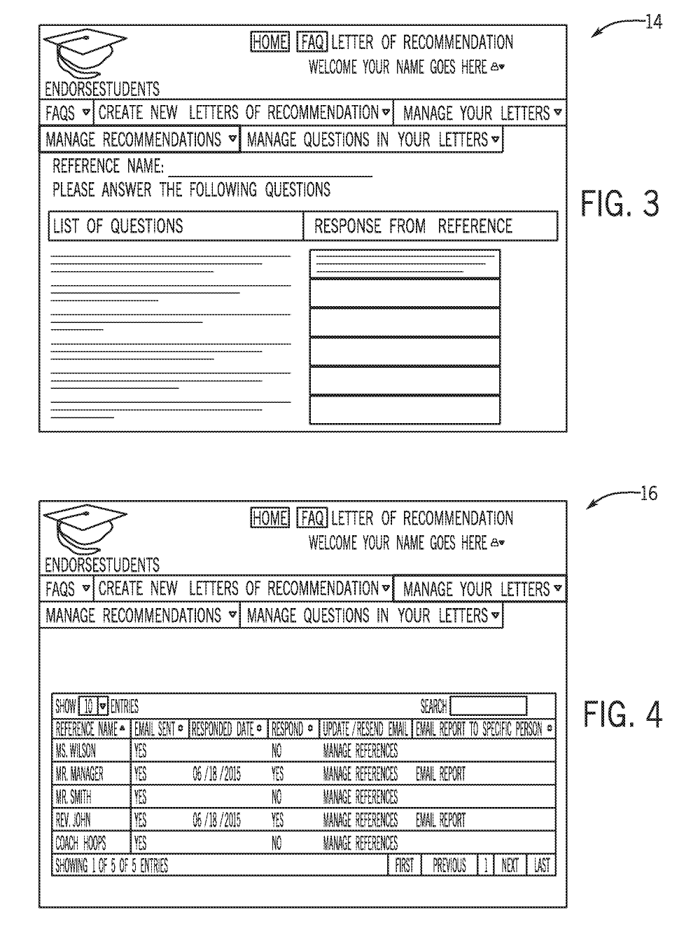

The reference providers receive the letter of recommendation request via e-mail, which may contain a link that allows the reference provider to then interact with the system via a computer, tablet or phone. The e-mail received by the reference provider is coded so that it automatically interacts with the system such that the reference provider's responses are associated with the applicant's account, presenting a display, similar to that shown in reference to FIG. 3, but without the applicant's account header. Responses from references are automatically transmitted to the user's account and compiled in the system. The user may then view the reference provider's responses to the questions through a page presented in a manage recommendations module, shown in FIG. 3.

With the compiled response, the system may also be configured to format the response into a single, standardized and professional letter of recommendation that will be available electronically in the applicant's account. As such, paper is not necessarily involved in the process unless an applicant, reference, or recipient has a need to print the letter of recommendation.

As seen in reference to FIG. 4, the system of the invention may also include a professional delivery system for the applicant to manage, track, update references and send their letters of recommendations to recipient schools, colleges, scholarship and grant programs. Each letter of recommendation includes a unique html link that allows the applicant to embed this link into any correspondence and allow the applicant, reference, or recipient school or other program to access the report with the click of a mouse.

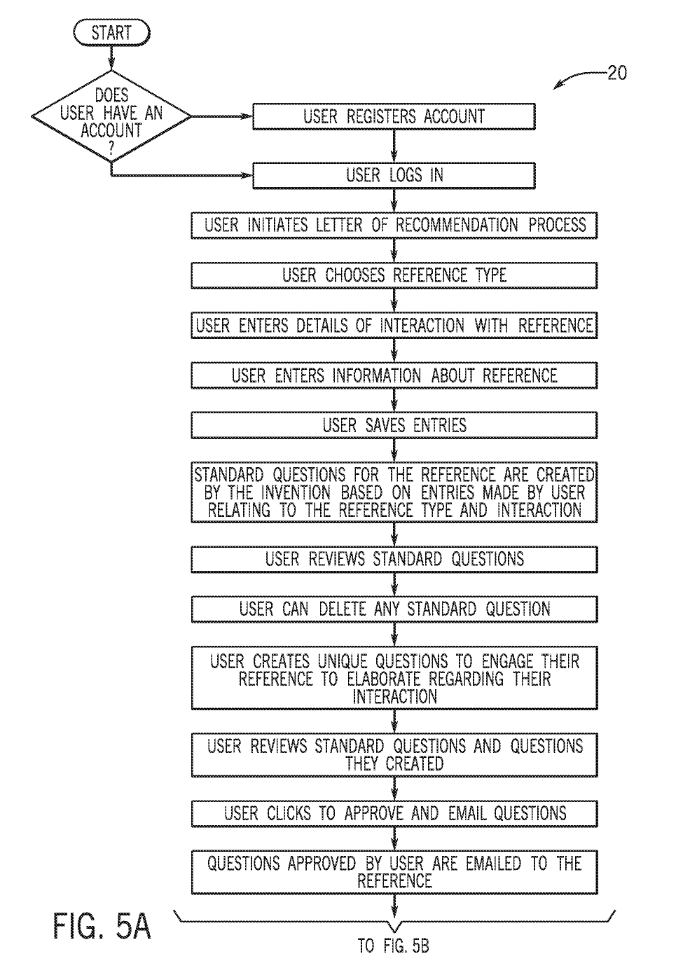

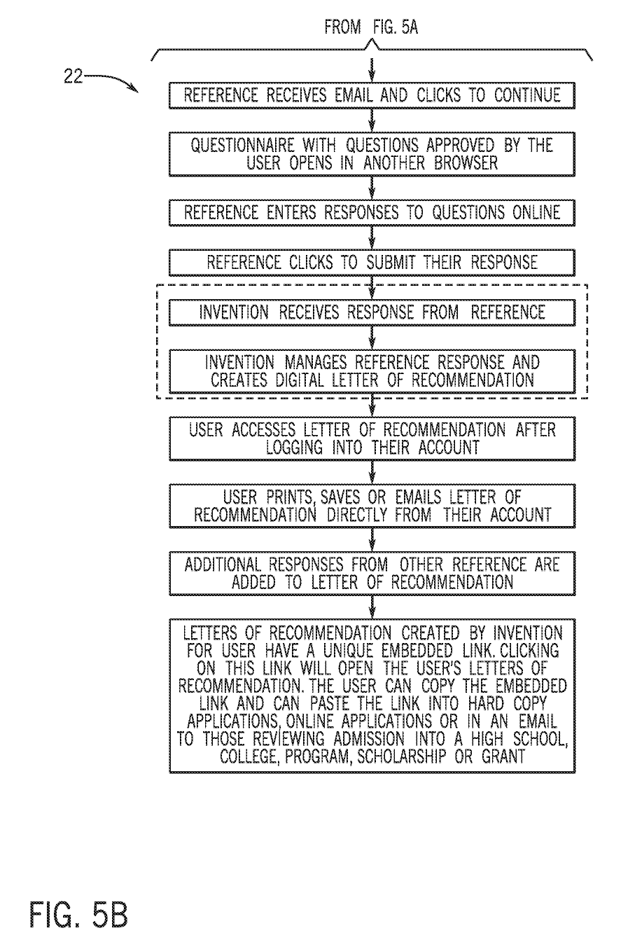

Letters of recommendation will be available to the applicant and recipient schools, scholarships, grants and internships programs with a computer, tablet or phone. The applicant can also email the letters of recommendation directly from the invention to a desired opportunity. As will be appreciated, the recipient of the letter of recommendation may be concerned with the authenticity of the letter of recommendation, which may be verified through the system by the recipient. As seen in reference to FIGS. 5A and 5B, a representative flow chart for the system and method is illustrated.

The system and method of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method for managing letters of recommendation for an applicant applying to a position, the computer implemented method comprising the steps of:
receiving an applicant request to initiate a request for a letter of recommendation to one or more reference providers identified according to a reference type in an account associated with the applicant;
presenting a plurality of reference questions to the applicant based on the selected reference type;
receiving an applicant assignment of the one or more reference providers to a selected group of the plurality of reference questions to solicit a recommendation based on the assigned reference questions;
generating an e-mail request to the one or more reference providers, wherein the e-mail contains the assigned reference questions for the one or more reference providers; and
transmitting the e-mail request to the one or more reference providers.

2. The computer implemented method of claim 1, wherein the reference type includes one or more of an employer, a teacher, an instructor, a professor, a coach, a volunteer coordinator, an organizational representative, and an internship coordinator.

3. The computer implemented method of claim 2, further comprising:
receiving the details of the applicant's interactions with identified reference provider from the applicant.

4. The computer implemented method of claim 3, further comprising:
generating the e-mail request to include the applicant entered details of the applicant's interactions with the reference provider.

5. The computer implemented method of claim 1, further comprising:
automatically receiving a response to the assigned reference questions from the reference provider, wherein the response is automatically linked to the applicant's account via a code transmitted with the e-mail request.

6. The computer implemented method of claim 5, further comprising:
generating a letter of recommendation based on the reference provider's response.

7. The computer implemented method of claim 6, further comprising:
providing an authenticated copy of the letter of recommendation to an admissions office.

8. The computer implemented method of claim 7, further comprising:
transmitting a link to the authenticated copy of the letter of recommendation to the admissions office.

9. The computer implemented method of claim 1, further comprising:
presenting a reference question editor to permit the applicant to select the reference questions.

10. The computer implemented method of claim 9, wherein the reference question editor is configured to receive a customized reference question from the applicant.

11. A computer program product for managing letters of recommendation for an applicant applying to a position, the computer program product comprising executable instructions which, when executed by one or more processors, cause the one or more processors to carry out the steps of:
receiving an applicant request to initiate a request for a letter of recommendation to one or more reference providers identified according to a reference type;
presenting a plurality of reference questions to the applicant based on the selected reference type;
receiving an applicant assignment of the one or more reference providers to a selected group of the plurality of reference questions to solicit a recommendation based on the assigned reference questions;
generating an e-mail request to the one or more reference providers, wherein the e-mail contains the assigned reference questions for the one or more reference providers; and
transmitting the e-mail request to the one or more reference providers.

12. The computer program product of claim 11, wherein the reference type includes one or more of an employer, a teacher, an instructor, a professor, a coach, a volunteer coordinator, an organizational representative, and an internship coordinator.

13. The computer program product of claim 12, further comprising:
receiving the details of the applicant's interactions with identified reference provider from the applicant.

14. The computer program product of claim 13, further comprising:
generating the e-mail request to include the applicant entered details of the applicant's interactions with the reference provider.

15. The computer program product of claim 11, further comprising:
automatically receiving a response to the assigned reference questions from the reference provider, wherein the response is automatically linked to the applicant's account via a code transmitted with the e-mail request.

16. The computer program product of claim 15, further comprising:
generating a letter of recommendation based on the reference provider's response.

17. The computer program product of claim 16, further comprising:
providing an authenticated copy of the letter of recommendation to an admissions office.

18. The computer program product of claim 17, further comprising:
transmitting a link to the authenticated copy of the letter of recommendation to the admissions office.

19. The computer program product of claim 11, further comprising:
presenting a reference question editor to permit the applicant to select the reference questions.

20. The computer program product of claim 19, wherein the reference question editor is configured to receive a customized reference question from the applicant.
